(19) United States
(12) Patent Application Publication
(10) Pub. No.: US 2024/0095588 A1
(43) Pub. Date: Mar. 21, 2024

(54) METHODS, APPARATUS AND MACHINE-READABLE MEDIUMS RELATING TO MACHINE LEARNING MODELS

(71) Applicant: Telefonaktiebolaget LM Ericsson (publ), Stockholm (SE)

(72) Inventors: Konstantinos VANDIKAS, Solna (SE); Aneta VULGARAKIS FELJAN, Stockholm (SE); Athanasios KARAPANTELAKIS, Solna (SE); Marin ORLIC, Bromma (SE); Selim ICKIN, Stocksund (SE)

(21) Appl. No.: 18/274,526

(22) PCT Filed: Feb. 15, 2021
(86) PCT No.: PCT/EP2021/053636

§ 371 Date: Jul. 27, 2023

(51) Int. Cl. G06N 20/00

(52) U.S. Cl. CPC G06N 20/00

(57) ABSTRACT

A method is provided for determining bias of machine learning models. The method includes: forming a training dataset including input data samples provided to a remote machine learning model developed using a machine learning process, and corresponding output data samples obtained from the remote machine learning model; training a local machine learning model which approximates the remote machine learning model using a machine learning process and the training dataset; and interrogating the trained local machine learning model to determine whether the remote machine learning model is biased with respect to one or more biasing data parameters.

### TECHNICAL FIELD

Embodiments of the disclosure relate to machine learning or artificial intelligence, and particularly to methods, apparatus and machine-readable mediums enabling the detection of bias in machine learning models.

### BACKGROUND

Machine learning models are extensively used to generate recommendations or predictions for a variety of activities, e.g., which word to type next (next word prediction), predicting whether or when a device is going to have a hardware failure (in preventive maintenance) and others.

A growing problem with machine learning models is that of bias. Machine learning models are initiated and trained on a set of training data until their performance is deemed acceptable according to one or more performance criteria. Typically a portion of the training data is set aside to act as test data to monitor the performance of the model. Once the model meets the performance criteria, it is available for use by consumers. The consumers provide input data to the model, and receive an output from the model, e.g., a prediction, classification, etc. The consumers thus have a “black box” perspective of the model, meaning that they do not know the true intention of the model, e.g., whether the model serves the best interests of the consumer, or is biased deliberately or inadvertently to serve different interests.

One effective way of knowing if a machine learning model is biased is to have direct access to the training dataset that was used for that model and the model itself. However, access to these prerequisites is typically forbidden since a great deal of money and effort is typically spent in the development of a machine learning model. In most cases, such models are protected as intellectual property, and consumers are allowed access only to query the model to obtain outputs based on some input data.

Sensitivity analysis can be used in order to identify the importance of each feature to the output of a machine learning model (e.g., a prediction, classification, decision, etc.). However, such analysis requires direct access to the training data and the model, and typically this is not available as noted above. Indeed, since machine learning models are typically black boxes, it is unknown whether the input data provided by the consumer is used directly as an input to the model, or whether the input data is converted, transformed or enriched with additional information prior to model execution. The same is true for output data; it is unknown whether the output data provided to the consumer is the direct output of the model, or whether the output of the model is converted, transformed or enriched after model execution.

Adversarial attacks can be used in order to shift the prediction of a machine learning model by carefully crafting the input. See, for example, a paper by Moore et al (“Modeling and Simultaneously Removing Bias via Adversarial Neural Networks”, https://arxiv.orq/pdf/1804.06909.pdf). However, such techniques are computationally expensive and can only be applied to neural networks.

### SUMMARY

It is an object of some embodiments of the disclosure to provide methods, apparatus and machine-readable mediums that enable bias of machine learning models to be detected, including machine learning models other than neural networks. It is an object of some embodiments of the disclosure to provide methods, apparatus and machine-readable mediums that enable bias of machine learning models to be mitigated.

According to a first aspect of the disclosure, there is provided a method for determining bias of machine learning models. The method comprises: forming a training dataset comprising input data samples provided to a remote machine learning model developed using a machine learning process, and corresponding output data samples obtained from the remote machine learning model; training a local machine learning model which approximates the remote machine learning model using a machine learning process and the training dataset; and interrogating the trained local machine learning model to determine whether the remote machine learning model is biased with respect to one or more biasing data parameters.

Apparatus and machine-readable media for performing this method are also provided. For example, in a further aspect, there is provided an apparatus for determining bias of machine learning models. The apparatus comprises processing circuitry and a machine-readable medium storing instructions which, when executed by the processing circuitry, cause the apparatus to: form a training dataset comprising input data samples provided to a remote machine learning model developed using a machine learning process, and corresponding output data samples obtained from the remote machine learning model; train a local machine learning model which approximates the remote machine learning model using a machine learning process and the training dataset; and interrogate the trained local machine learning model to determine whether the remote machine learning model is biased with respect to one or more biasing data parameters.

One advantage of embodiments of the disclosure is that they enable biased features of a model to be identified and omitted without having access to the actual model or the training data that was used to train it. A further advantage of methods of the disclosure is that they can be used to monitor transparently if a model suffers from bias without affecting the normal process of the model. Such monitoring can be performed and then used to generate a replacement model that does not suffer from such bias.

### BRIEF DESCRIPTION OF THE DRAWINGS

Embodiments of the present disclosure will now be described, by way of example only, with reference to the following drawings:

FIG. 1 shows a system according to embodiments of the disclosure;

FIG. 2 is a flowchart of a method enabling the detection of bias in a machine learning model according to embodiments of the disclosure;

FIG. 3 is a flowchart of a method enabling the mitigation of bias in a machine learning model according to embodiments of the disclosure;

FIGS. 4A and 4B are bar charts showing Shapely values for a plurality of features provided as input to a machine learning model;

FIG. 5 is a signalling diagram showing signalling during execution of the method described in FIG. 2 according to one embodiment;

FIGS. 6A and 6B are schematic diagrams showing the effects of an imbalanced training dataset;

FIG. 7 is a flowchart of a method enabling the mitigation of bias in a machine learning model according to further embodiments of the disclosure; and

FIGS. 8 and 9 are schematic diagrams showing apparatus according to embodiments of the disclosure.

### DETAILED DESCRIPTION

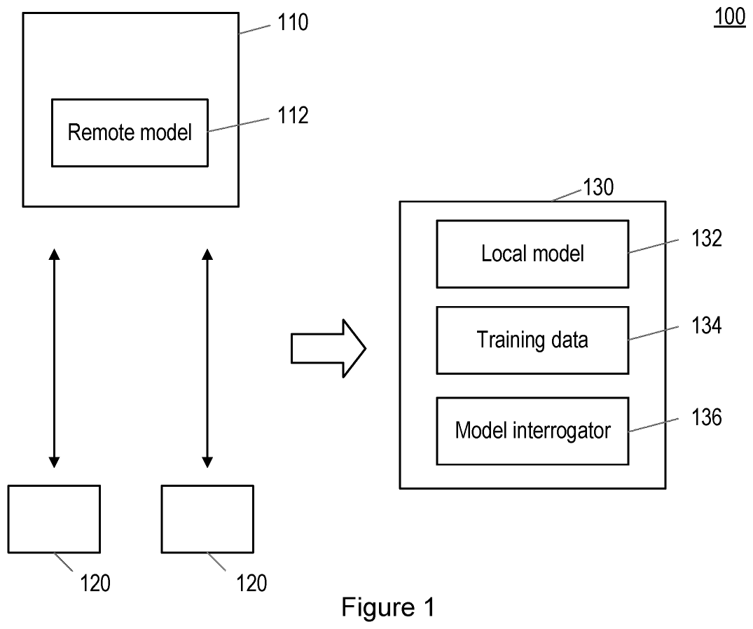

FIG. 1 shows a system 100 according to embodiments of the disclosure, comprising a network server 110, one or more consumer devices 120 and a model analyser 130. The network server 110 stores a machine learning model 112, hereinafter referred as “model” also, which can be queried by the consumer devices 120 to provide an output. Thus, the consumer devices 120 transmit request messages to the network server 110, comprising input data for the model 112, and receive response messages from the network server 110, comprising output data from the model 112.

Embodiments of the present disclosure have a broad ambit, and are applicable in a wide range of scenarios. The model 112 may therefore perform a correspondingly wide range of functions. For example, the model 112 may have a prediction function, and predict outcomes or values based on the input data that is provided to it. In another example, the model 112 may have a classifying function, and classify the input data into one or more classifications. In a further example, the model 112 may take one or more decisions based on the input data. Those skilled in the art will appreciate that machine learning models may be used for a wide range of functions and the present disclosure is not limited to the examples listed above.

The system 100 may similarly be implemented in a wide range of technical scenarios. In one example, the system 100 comprises a communications network, e.g., a wireless network such as a cellular network. In such embodiments, the consumer devices 120 may comprise network devices, such as wireless devices (e.g., user equipments, UEs), network nodes (e.g., radio access network nodes, base stations, NodeBs, evolved NodeBs, 5G NodeBs, etc) or network functions (e.g., core network functions, such as the Session Management Function, the Access and Mobility Function, the User Plane Function, the Policy Control Function, etc). In some embodiments, the consumer devices 120 may comprise any combination of these network devices; in other embodiments, the consumer devices 120 may comprise only a single type of network device (i.e., a single type of network device accesses the model 112).

In the context of the communication network, the model 112 may be utilized to provide outputs concerning performance of the network or components thereof. For example, the model 112 may predict the failure of network components, allowing pre-emptive maintenance of those network components before they fail and thus reducing network downtime. In another example, the model 112 may detect network traffic anomalies such that faults are detected before they can cause significant damage or reduce user experience. In this case, the model 112 may perform a classification function, classifying network traffic patterns into “normal” and “anomalous” categories, with the latter category being indicative of network malfunction in one or more components. In a further example, the model 112 may classify or predict user traffic to enable appropriate provision of services to one or more wireless devices. For example, the model 112 may predict a surge in user traffic and thus enable adequate network resources to be allocated to handle the peak in demand. In another example, the model 112 may take a decision on the basis of which a radio access network operation is performed, such as cell handover, changing the number of active cells for a wireless device, changing transmission parameters such as transmit powers, modulation and coding schemes, etc.

The system 100 may also be implemented in different scenarios. For example, the model 112 may provide outputs relating to control of machinery (e.g., in a factory or other manufacturing plant) or autonomous vehicles. The model may be used in a medical context, e.g., to identify anomalies and/or diagnose medical conditions based on medical images or other medical data. The model 112 may alternatively be used in a business context: in procurement, to select suppliers; in recruitment, to select candidates for interview, or job offers; in finance, to decide on loan applications or make investment decisions. The model 112 may provide outputs for productivity, such as predicting a next word based on one or more preceding words entered by a user of an electronic device. In this latter example, the consumer devices 120 may comprise smart phones, tablets, computers, or other consumer electronic devices.

Thus, the model 112 may have any of a wide range of functions, and be utilized in a wide range of technical fields.

Herein, the machine learning model 112 in the network server 110 hereinafter is referred to as the “remote model” or “model” also, in that the model 112 is remote to the consumer devices 120 and the model analyser 130, and the consumer devices 120 and the model analyser 130 lack information relating to the model 112 itself. For example, the consumer devices 120 and the model analyser 130 may lack information relating to the implementation of the model 112, or the machine learning process used to train the model 112. Additionally or alternatively, the consumer devices 120 and the model analyser 130 may lack information relating to the processing of the input data at the network server 110. For example, the input data may be subject to one or more transformations, or be supplemented with additional data prior to being input to the model 112. The consumer devices 120 and the model analyser 130 may alternatively or additionally lack information relating to the training data used to train the model 112.

The consumer devices 120 utilize the remote model 112 by transmitting request messages comprising input data to the network server 110, and by receiving response messages comprising output data from the network server 110. However, the consumer devices 120 do not have knowledge of the remote model 112 itself, or of how the input data is processed in order to return the output data. Thus, the remote model 112 may be implemented using any techniques or algorithms, such as a neural network, a decision tree, a support vector machine, a regression model, a Bayesian network, etc, and have been trained using any machine learning process (e.g., supervised, unsupervised, reinforcement learning, adversarial learning, etc).

The effectiveness of machine learning models depends on the dataset that is utilized to train them. A machine learning model will reflect any biases that are contained within the training dataset, and in order to mitigate this it is important to utilize a balanced and diverse training dataset. However, as noted above, the training dataset—as well as the model itself—represents valuable intellectual property and is typically not shared widely. Therefore, consumers of machine learning models are unable to determine whether those models are biased.

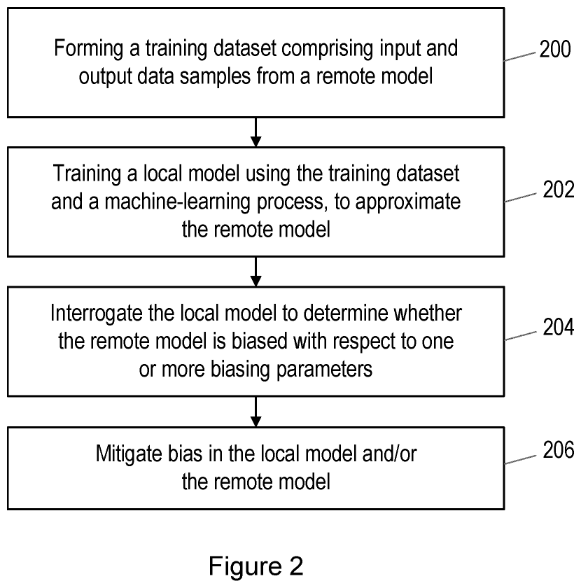

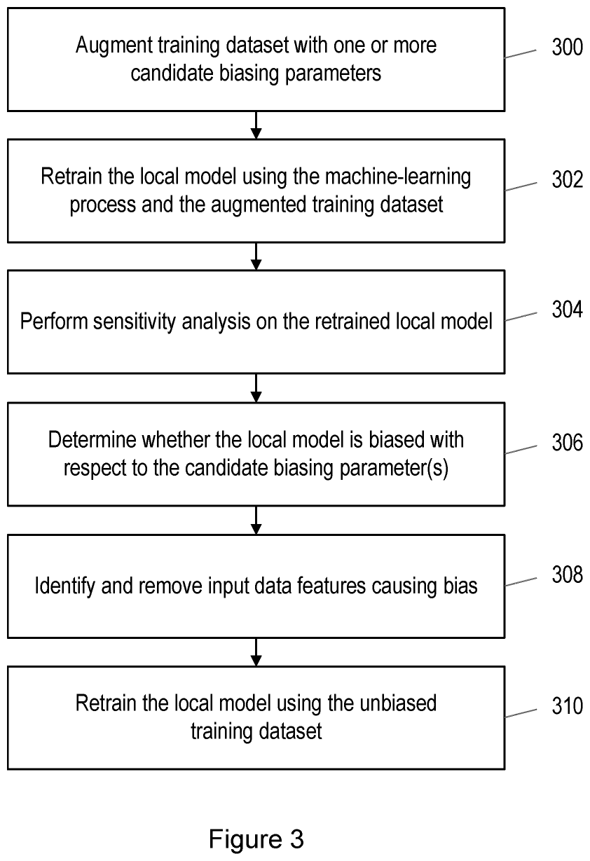

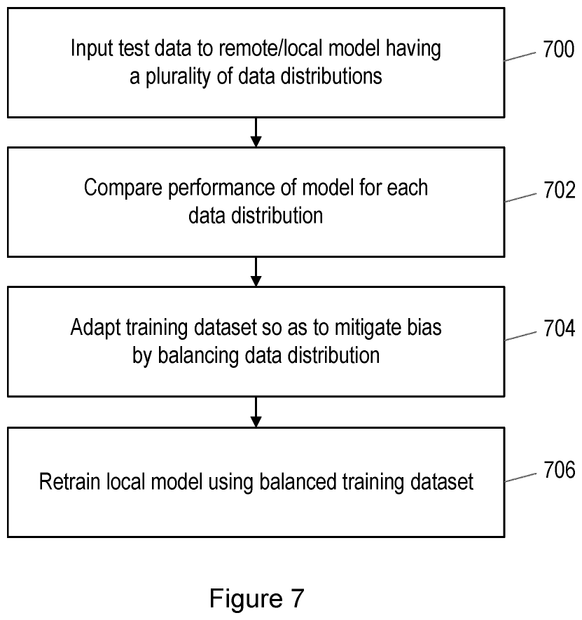

Embodiments of the disclosure address this problem by querying the remote model 112, and building a training dataset comprising multiple input data samples provided to the network server 110, and corresponding output data samples provided by the network server 110. This training dataset is used to train another machine learning model, referred to as the “local model” herein, which approximates the remote model 112. As described in further detail below (see in particular step 202 in FIG. 2), the local model may additionally approximate the functioning of the entire network server in producing the output data samples, i.e., including any processing of the data before or after execution of the remote model 112. This local model may then be interrogated in order to determine whether the remote model 112 is biased with respect to one or more biasing data parameters or features. For further detail regarding this aspect, see in particular step 204 of FIG. 2, the discussion with respect to steps 300 to 306 of FIG. 3, and steps 700 and 702 of FIG. 7. The local model may also be adapted and/or retrained to mitigate biases that are detected. Further detail regarding this aspect may be found below in step 206 of FIG. 2, steps 308 and 310 of FIG. 3, and steps 704 and 706 of FIG. 7.

Thus, in the illustrated embodiment, the model analyser 130 is configured to enable the detection of bias in machine learning models. The model analyser 130 may be implemented in one or more network nodes or computer servers. In the following, unless otherwise stated, references to “network nodes” include references to “computer servers”. When implemented in multiple network nodes, the functions described below as being performed by the model analyser 130 may be distributed across those multiple network nodes. In one embodiment (not illustrated), the model analyser 130 is implemented in one or more of the consumer devices 120.

The model analyser 130 is operable to form a training dataset 134 comprising input data samples provided to the network server 110, and corresponding output data samples provided by the network server 110. Thus the training set comprises a plurality of data tuples, each comprising input data samples (e.g., as provided in request messages by one or more consumer devices 120) and corresponding output data samples (e.g., as provided in response messages by the network server 110). Such data tuples may be obtained by communicating with the network server 110 itself, by communicating with one or more consumer devices 120, by inspecting the request and response messages transmitted between the consumer device(s) 120 and the network server 110, or any combination of one or more of these methods. The training dataset 134 so formed may relate to requests from one or multiple consumer devices 120. When the model analyser 130 is implemented within a consumer device 120, in particular, the training dataset 134 may correspond to input and output data samples related to that consumer device 120. However, even in this case, it is not precluded that input and output data samples from other consumer devices may form part of the training dataset 134.

The model analyser 130 further instantiates a local machine learning model 132 (hereinafter also referred to as the “local model”) and trains that local model 132 using the training dataset 134 and a machine learning process. Thus, the local model 132 is trained to reproduce the output data samples based on the input data samples, and in this way approximates the remote model 112. It will be appreciated that, as the training dataset 134 comprises the input data and the output data provided to and from the network server 110, the local model 132 will approximate any functionality of the network server 110 acting on the input data. That is, the local model 132 will approximate the remote model 112, and also any pre- or post-processing of the data in the network server 110. In this way, the model analyser 130 does not need to know the nature of the remote model 112, or whether there is any pre- or post-processing of the data; the local model attempts to replicate the entire functionality of the network server 110 as applied to the input data, in order to obtain the corresponding output data.

The model analyser 130 further comprises a model interrogator 136, which is configured to interrogate the local model 132 to determine whether the remote model 112 is biased with respect to one or more biasing parameters. The model interrogator 136 may additionally be configured to mitigate any bias which is identified. Further detail regarding the functions of the model analyser 130 and its constituent parts are discussed below with reference to FIGS. 2, 3 and 7.

FIG. 2 is a flowchart of a method according to embodiments of the disclosure. The method may be performed by a network node or a computer, such as the model analyser 130 described above with respect to FIG. 1. It will be understood that the steps of the method shown in FIG. 2 may be distributed across multiple network nodes or computers, with different entities performing the different steps of the method.

The method begins in step 200, in which the model analyser forms a training dataset 134 comprising input data samples (X_{original}) provided to a remote machine learning model (e.g., the remote model 112) and output data samples (Y_{original}) original) provided by the remote machine learning model in response to those input data samples. In some embodiments, the training dataset may comprise input data samples provided to a network node or server implementing a remote machine learning model (e.g., the network server 110) and output data samples provided by the network node or server in response to those input data samples. The input data samples may be provided to the network server or the remote machine learning model by consumer devices of the remote machine learning model, with the output data samples being provided to those consumer devices. Thus, the training dataset comprises a plurality of data tuples, each comprising input data samples (e.g., as provided in request messages by one or more consumer devices 120) and corresponding output data samples (e.g., as provided in response messages by the network server 110).

The input and output data samples may be obtained by communicating with the network server 110 itself, by communicating with one or more consumer devices 120, by inspecting the request and response messages transmitted between the consumer device(s) and the network server, or any combination of one or more of these methods. In one embodiment, the input data samples may be provided by a government or other agency providing suitable datasets for the detection of biases; these input data samples may be provided to the network server 110 by the model analyser 130 or any one or more of the consumer devices 120. The training dataset so formed may therefore relate to requests from one consumer device or from multiple consumer devices. Where the model analyser is implemented within a consumer device, the training dataset may correspond to input and output data samples related to that consumer device (although this is not necessarily the case).

The method proceeds to step 202, in which the model analyser instantiates and trains a local machine learning model 132, using the training data obtained in step 200 and a machine learning process. That is, the local machine learning model is trained to produce the output data samples based on the input data samples (X_{original}→Y_{original}). In this way, the local model is therefore trained to approximate the remote machine learning model. Depending on the nature of the training dataset, the local model may approximate the entire functionality of the network server implementing the remote model, i.e., approximating the function of the remote model and also any pre- or post-processing of the data. For example, the local model may approximate the functionality of the network server (as opposed to just the remote model) where the training dataset comprises input data samples provided to the network server and output data samples provided by the network server.

The local machine learning model and the training in step 202 may take any suitable form. For example, the local model may utilize any implementation, such as a neural network, a decision tree, a support vector machine, a regression model, a Bayesian network, etc, and be trained using any machine learning process (e.g., supervised, unsupervised, reinforcement learning, adversarial learning, etc). Those skilled in the art will be familiar with each of these techniques, and the present disclosure is not limited in this respect.

It will particularly be understood that, as the implementation of the remote model may be unknown, the implementation of the local model may be different to that of the remote model. Similarly, as the machine learning process used to train the remote model may be unknown, the machine learning process used to train the local model may be different. However, the function of the remote model is known, and this may inform the choice of implementation and/or machine learning process used for the local model. For example, certain types of model implementation may be better suited for particular functions, such as state vector machines for classification, neural networks or decision trees for decision making, neural networks or regression models for predicting, etc.

The output of step 202 is therefore a trained local model, which approximates the function of the remote model and, potentially, that of the network server implementing the remote model.

In step 204, the model analyser (e.g., model interrogator 136) interrogates the local model to determine whether the remote model (and also the local model, which approximates the remote model) is biased with respect to one or more biasing parameters.

As used herein, a biasing parameter is a data parameter, which may be present in the input data features provided to the local model or not, against which the local model performs poorly (e.g., inaccurately). For example, the local model may perform poorly when the biasing parameter takes particular values.

Many well-known example of bias relate to social issues, such as sexism or racism. Such issues may be manifested in machine learning models by a next-word prediction model suggesting gender stereotypical words in response to certain input words. For example, the prediction model may erroneously predict that a nurse is female, or that a doctor is male. However, bias can also be present in a technical context. For example, a machine learning model may erroneously associate mobile network operators or equipment manufacturers with certain outcomes, e.g., a greater likelihood of equipment failure or poor performance.

Rather than being reflective of reality, the bias referred to herein is generally reflective of a training dataset that is too small, and/or insufficiently diverse. A machine learning model that is trained using an imbalanced training dataset is likely to perform poorly when provided with input data from a balanced data population. For example, suppose that a machine learning model is trained to predict an amount of time until a network component fails. The machine learning model is trained with data relating to two different network operators: network operators A and B. However, 90% of that data comes from network operator A and only 10% comes from network operator B. As there are relatively few data samples for network operator B, it is more likely that data relating to network operator B will not be reflective of reality. Thus the machine learning model may associate network operator B, or the data parameter “network operator” itself, more strongly with particular outcomes than is justified. In this case, the parameter “network operator” may be determined to be a biasing parameter.

In step 206, the model analyser takes one or more actions to mitigate the bias in the local model and/or the remote model. For example, the training dataset may be analysed to identify one or more features of the training data which are correlated with the biasing parameter. Any features identified as causing bias may then be removed from the training data and the local model retrained. Where the training dataset is determined to be imbalanced with respect to one or more parameters, for example, the training dataset may be augmented with additional data so as to become more balanced, and the local model retrained.

Methods for interrogating the local model to determine whether the remote model is biased and taking action to mitigate the bias are described in more detail in FIGS. 3 and 7, below.

FIG. 3 is a flowchart of a method for identifying biasing parameters and mitigating the effect of biasing parameters according to embodiments of the disclosure. The method may be performed by the model analyser 130 described above, and sets out an example of the processing which may take place in steps 204 and 206 described above with respect to FIG. 2. Thus, the method may proceed in the context of a local model that has been trained, e.g., using a training dataset obtained as set out in steps 200 and 202 described above.

In step 300, the training dataset (which may also be termed the “original” training dataset herein) is augmented with one or more candidate biasing parameters. For example, the one or more candidate biasing parameters may be added to the original training dataset as one or more additional input features. As noted above, a biasing parameter is a data parameter, which may be present in the input data features provided to the local model or not, against which the local model performs poorly (e.g., inaccurately). One of the purposes of the method shown in FIG. 3 is to identify such biasing parameters, and thus in step 300 the biasing parameters are initially referred to as “candidate” biasing parameters, in that the purpose of the method is to determine whether the candidate biasing parameters are indeed parameters that bias the local model (and hence the remote model).

The candidate biasing parameters may be selected from the plurality of data parameters which are available to the model analyser. That is, the model analyser may be aware of additional data parameters than those which form the input data samples in the training dataset. For example, where the model analyser is implemented within a consumer device, the model analyser will generally have access to numerous data parameters relating to the characteristics, function and performance of the consumer device, and not only those which are included within the input data samples sent to the remote model. Where the model analyser is implemented outside a consumer device, the model analyser may request additional information corresponding to the one or more candidate biasing parameters from the consumer devices.

In step 302, the local model is retrained using a machine learning process (e.g., the same machine learning process as that used in step 202 described above) and the augmented training dataset output by step 300. Thus the local model is retrained to generate the output data samples (Y_{original}) original) using the original input data samples and also the additional candidate biasing parameters (X_{Augmented}). The retrained local model therefore additionally captures the relationship between the candidate biasing parameters and the corresponding output data samples (X_{Augmented}→Y_{Original}).

In step 304, sensitivity analysis is performed on the retrained local model. Sensitivity analysis is a term that covers a large number of known techniques. As used herein, the purpose of sensitivity analysis is to determine the importance of the input features to the determination of the output data.

In one embodiment, the sensitivity analysis comprises iteratively omitting input features (e.g., one feature at a time) from the training dataset and then measuring how the output of the local model changes. If the output changes relatively significantly, then the omitted input feature is relatively important to the model; if the output changes relatively insignificantly, then the omitted input feature is relatively unimportant to the model. Other techniques can be used to determine the sensitivity of the retrained local model to its input features, however. For example, the sensitivity analysis may be more complex, using the derivative of the output with respect to the input at some fixed point in the input space, using regression analysis, measuring the variance of the output with respect to the input, etc. The present disclosure is not limited in this respect.

One method of quantifying the importance of input data features to the retrained local model is to calculate the Shapley value for each input data feature. Those skilled in the art will be familiar with Shapley values. The Shapley value of an input data feature may be defined as the mean average impact of that input data feature on the output of the model, that is, the mean average of the magnitude of the marginal value of the input data feature being absent from the training dataset. In colloquial terms, the Shapley value for a particular input data feature is an indication of the importance of that input data feature to the determination of the output by the model. Larger Shapley values are indicative of a feature that is more important; smaller Shapley values are indicative of a feature that is less important. Those skilled in the art will also appreciate that Shapley values are merely one example of many methods for quantifying the importance of input data features to the retrained local model. Alternative methods for quantifying the importance of input data features to the retrained local model include Local Interpretable Model-Agnostic Explanations (LIME) and decision trees, for example.

In step 306, the model analyser determines whether the local model (and hence the remote model), X_{Original}→Y_{Original}, is biased with respect to the one or more candidate biasing parameters, based on the sensitivity analysis performed in step 304 and the accuracy of the retrained local model (X_{Augmented}→Y_{Original}). For example, the model analyser may conclude that the local model is biased with respect to the biasing parameters responsive to one or more of the following:
a determination that the accuracy of retrained local model (X_{Augmented}→Y_{Original}) is similar to the accuracy of the original local model (X_{Original}→Y_{Original}). For example, the model analyser may determine that the accuracy is similar if the accuracy of the retrained local model is at least a threshold percentage of the accuracy of the original local model (e.g., the threshold percentage may be 90%, such that where the accuracy of the original local model is 0.9, the accuracy of the retrained local model may be required to be at least 0.81).
a determination that the candidate biasing parameter is relatively important to the retrained local model (X_{Augmented}→Y_{Original}). For example, the model analyser may determine that a candidate biasing parameter is important to the retrained local model if the Shapley value exceeds a threshold; or if the candidate biasing parameter appears in the top n input parameters of the augmented training dataset ranked according to their Shapley values, etc (where n is an integer).

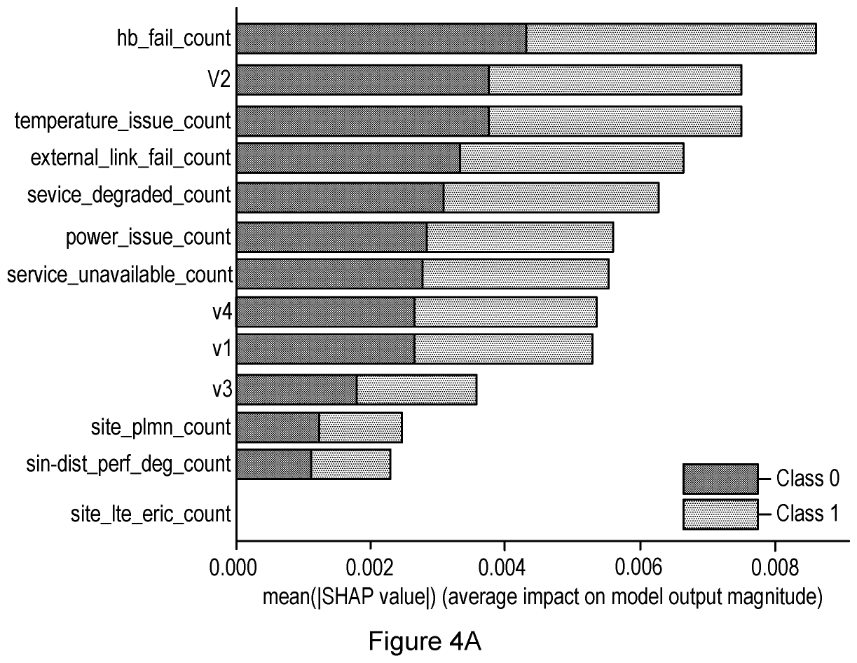

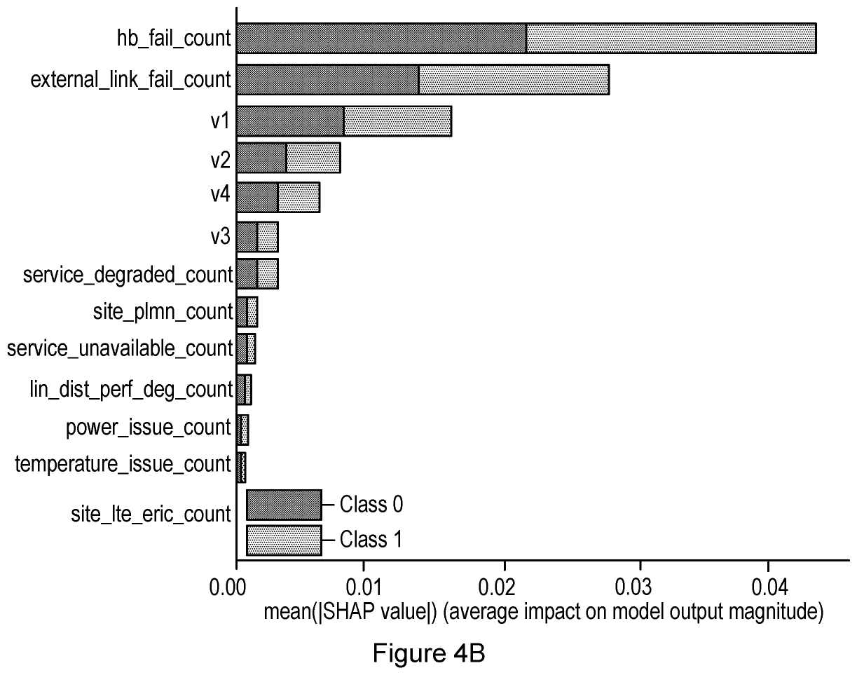

FIGS. 4A and 4B are bar charts showing examples of Shapley values for a plurality of features provided as input to a machine learning model.

In the illustrated example, the machine learning model is configured to predict hardware fault, and is particularly configured to predict whether a piece of hardware will fail within the coming week. The machine learning model uses the following input features X=[‘external_link_fail_count’ (a count of the number of failures in the external link between the hardware site and a core network), ‘service_degraded_count’ (a count of the number of times the service provided by the hardware was degraded), ‘service_unavailable_count’ (a count of the number of times the service provided by the hardware was unavailable), ‘lin_dist_perf_deg_count’ (the linear distance, e.g., in time, between hardware failures), ‘hb_fail_count’ (a count of the number of failures in high band hardware), ‘site_lte_eric_count’ (a count of the number of Long-term Evolution baseband units), ‘site_plmn_count’ (a count of the number of public land mobile networks available), ‘power_issue_count’ (a count of the number of times the hardware experienced a power issue), ‘temperature_issue_count’ (a count of the number of times the hardware experienced a temperature issue)]. The output is a prediction as to whether or not a piece of hardware will fail next week y=[target_hwfault_nextweek].

The hardware is provided by four different vendors, and we wish to know whether the local model is biased with respect to the vendors. Thus, the input data is augmented with the vendor information as biasing parameters. The name of the vendor is a string and therefore a categorical feature. One hot encoding is used to produce a binary representation of all possible permutations of the domain values—in this case we consider 4 possible vendors: V1, V2, V3 and V4.

FIG. 4A shows the Shapley values for an unbiased version of the model. It can be seen that V2 ranks rather high, but that does not apply to the other vendors V1, V3 and V4. Further, the Shapley values for the vendors are not significantly larger than those for other input features. Thus, although there is a small indication, the model shown in FIG. 4A may not be biased based on the vendor.

FIG. 4B shows the Shapley values for a biased version of the model. In this example, it can be seen that the bias towards the vendor information is more profound since features V1, V2, V3, and V4 have become much important to the prediction of the model, and are also more important than many other features, such as power_issue_count, service_unavailable_count and so on.

Returning to FIG. 3 and, if the local model is not determined to be biased with respect to the one or more candidate biasing parameters in step 306, the method may end at that point. However, if the local model is determined to be biased with respect to a candidate biasing parameter, the method may proceed to take one or more actions to mitigate the bias in the local model.

In step 308, the model analyser identifies and removes one or more input data features of the original training dataset which result in the local model being biased, referred to as biasing features.

In one embodiment, the biasing features are identified by augmenting the original training dataset again with the biasing parameter with respect to which the local model was determined to be biased in step 306. However, in this step the original training dataset is augmented with the biasing parameter as a label or target, and not an input feature. A new machine learning model is trained using a machine learning process to generate the biasing parameter as an output (label) based on the input data samples, i.e., X_{Original}→Y_{BiasLabel}. For example, if the biasing parameter is a network operator, the new machine learning model is trained to use the original input data samples to determine the network operator.

It will be noted here that the new machine learning model, X_{Original}→Y_{BiasLabel}, may have a different implementation and/or utilize a different machine learning process to the local model or the retrained local model. Again, however, any suitable model implementation and machine learning process may be used.

Input features that are relatively important to the output determination of the new machine learning model, X_{Original}→Y_{BiasLabel}, will correlate with those input features that introduce the bias with respect to the biasing parameter in the original local model X_{Original}→Y_{Original}.

Thus, in one embodiment, the model analyser performs sensitivity analysis on the new machine learning model (X_{Original}→Y_{BiasLabel}), to determine the importance of input data features to the determination of the bias parameter as label, and to identify those features which are more important than others as biasing features. The sensitivity analysis may be substantially as described above with respect to step 304, and thus may comprise the iterative removal of each feature from the training dataset and measurement of the impact the removal had on the output of the model. Again, the importance of each input feature may be quantified using Shapley values.

The input feature having the greatest importance to the model (e.g., the highest Shapley value) may be identified as a biasing feature and removed from the original training dataset X_{Original} to produce an updated training dataset X_{Updated}. In one embodiment, the m input features (where m is an integer greater than or equal to one) having the greatest importance to the model (e.g., the highest Shapley values) may be identified as biasing features and removed from the original training dataset X_{Original} to produce the updated training dataset X_{Updated}.

In one embodiment, this process is repeated iteratively to identify and remove further biasing features from the training dataset. In such embodiments, the machine learning model X_{Original}→Y_{BiasLabel} is retrained using the updated training dataset, X_{Updated}→Y_{BiasLabel}, and sensitivity analysis is performed on the retrained model to identify any further features which contribute significantly to bias in the training dataset. Thus, again input feature or m input features having the greatest importance to the retrained model may be identified as biasing features and removed from the updated training dataset.

The iterations may repeat until some stopping criterion is reached. For example, the stopping criterion may be that a maximum number of iterations is performed, or a maximum number of input features are removed from the training dataset. Alternatively, the stopping criterion may be a determination that no input feature (particularly no input feature which is suspected to be associated with potential bias, such as vendor name, day of the week, etc.) is significantly more important than other input features. For example, the model analyser may determine that no input feature has an importance (e.g., a Shapley value) above a certain threshold (where the threshold is defined relative to the average Shapley value for all input features, or relative to some other statistical metric for the input features).

The final output of step 308 is a training dataset from which one or more biasing features have been removed, X_{Unbiased}. In step 310, the local model is retrained using this unbiased training dataset, X_{Unbiased}→Y_{Original}, and a machine learning process (e.g., the same machine learning process as that used in step 302 described above). Thus the local model is retrained to generate the output data samples (Y_{Original}) using the original training dataset from which the biasing features have been removed (X_{Augmented}), and the local model itself is no longer biased with respect to the biasing parameter identified in step 300.

According to one embodiment, the local model is retrained with the unbiased training dataset as follows. The input features from the unbiased training dataset are input to the remote model, together with any input features that have been removed (i.e., in step 308 above). The remote model returns an output Y′. The input features from the unbiased training dataset are also input to the local model, but without the input features that were removed. The local model generates a corresponding output Y″. The local model may then be adapted iteratively so as to minimize the difference between Y″ and Y′. The iterations may stop once the two outputs Y′ and Y″ converge (e.g., to within some threshold value).

In accordance with some embodiments of the disclosure, an indication of input features which are identified as biasing features may be stored by the model analyser. The indication may be stored at the model analyser (e.g., in local memory), or at a separate device (e.g., a separate network node). The indication of the input features identified as biasing features may be stored in association with metadata related to the model. For example, the metadata may comprise one or more of: an indication of the number and type of input features; an indication of the output data; an indication of the purpose or function of the model; and an indication of the local model implementation. In this way, those input features which cause the machine learning model to be biased may be used to debias other, similar machine learning models.

For example, in one embodiment, the model analyser may obtain an indication of the biasing input features during step 308 and utilize that indication to identify and remove input features from the training dataset. For example, in step 308, the model analyser may access the local memory or communicate with the separate device to identify relevant input features which have previously been determined as causing bias in machine learning models. Once identified, the input features may be assumed to cause bias in the machine learning model under analysis and removed from the training dataset in step 308.

Alternatively or additionally, the indication of the biasing input features may be utilized during step 306, as an additional input to determine whether or not the machine learning model is biased with respect to a biasing parameter. For example, when assessing the sensitivity of the machine learning model with respect to its input data features, the model analyser may additionally take into account whether or not those input data features have previously been found to cause bias in machine learning models.

In either embodiment, input features previously determined to cause bias may be identified as relevant to a particular machine learning model based on one or more similarities between the particular machine learning model under analysis and machine learning models in which the input features have previously been determined to cause bias. For example, in one embodiment, an input feature may be determined as being relevant if it belongs to the input data features for the machine learning model under analysis. Alternatively or additionally, an input feature may be determined as being relevant if the machine learning model under analysis has a similar or the same function as a machine learning model in which the input feature has previously been determined to cause bias, e.g., if both machine learning models perform a classification function, a prediction function, etc. Alternatively or additionally, an input feature may be determined as being relevant if the machine learning model under analysis is implemented in the same or a similar technical field (e.g., communication networks, smart factories, medical analysis, financial analysis, etc) as a machine learning model in which the input feature has previously been determined to cause bias. In further embodiments, input features may be identified as relevant based on a combination of any one or more of these similarities. Thus, an input feature may be identified as relevant if it belongs to the set of input data features of the machine learning model under analysis, and the machine learning model under analysis performs the same function in the same technical field as a machine learning model in which the input feature has previously been found to cause bias.

The model analyser may therefore utilize a search query to search a database or list of input features previously determined to cause bias in machine learning models, whether that database is stored locally or in a separate device. The search query may contain an indication of one or more of: the set of input data features for the machine learning model under analysis; the function of the machine learning model under analysis; and the technical field of the machine learning model under analysis. Where the database is implemented remotely, in a separate device, that separate device can use the search query to search for relevant input data features and return a list of those input data features to the model analyser.

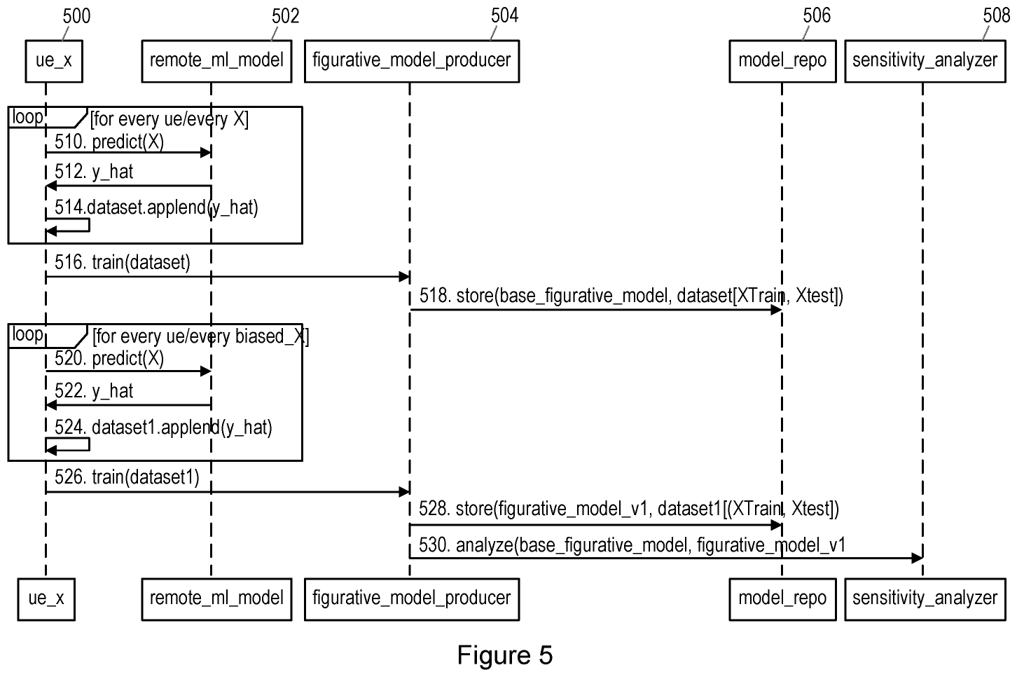

FIG. 5 is a signalling diagram showing signalling during execution of the method described in FIGS. 2 and 3 according to one embodiment. The signalling is implemented in a communications system, where the consumer devices are wireless devices or user equipments (UEs) 500. The system further comprises a remote machine learning model 502 (e.g., implemented in a network server or function, such as the Network Data Analytics Function, NWDAF), a figurative model producer 504, a model repository 506 and a sensitivity analyser 508. It will be apparent from the discussion above that the figurative model producer 504, the model repository 506 and the sensitivity analyser 508 perform the combined functions of the model analyser 130. Thus, as noted above, the functions of the model analyser 130 may be distributed across multiple entities.

In the illustrated embodiment, the remove machine learning model 502 performs a prediction function. Thus a UE 500 queries the remote machine learning model by transmitting a request message 510 for the remote machine learning model 502 to predict some value based on input data X. The remote machine learning model 502 inputs the input data X and outputs a prediction y (message 512). The UE 500 stores 514 the prediction y in a manner such that it is associated with the input data X.

This process is repeated multiple times, by one or multiple UEs, such that a training dataset of data tuples (X,y) is aggregated over time. In the illustrated embodiment, the training data is aggregated at the UE or UEs 500, before being transmitted 516 to the figurative model producer 504. In other embodiments, the data tuples may be transmitted to or otherwise obtained by the figurative model producer 504 and aggregated there to form the training dataset. For example, a proxy server may be used for the purposes of tracking requests towards the remote machine learning model 502 transparently. See also step 200, described above.

The figurative model producer 504 trains a local machine learning model to approximate the remote machine learning model 502, i.e., X y, and outputs 518 the local machine learning model to the model repository 506 for storage. In the illustrated embodiment, the training dataset and the test dataset (which may comprise a proportion of the training dataset reserved for testing purposes) are also transmitted to the model repository 506 for storage. See step 202 described above.

These processes are repeated again, with the UEs 500 again querying the remote machine learning model 502, transmitting a request message 520 comprising input data X, to obtain prediction outputs y in message 522. However, this time the output y is stored 524 with the input data X and augmented with one or more candidate biasing parameters, e.g., network operators. The augmented training dataset is transmitted 526 to the figurative model producer 504, which retrains the local machine learning model using the augmented training dataset and transmits 528 the retrained machine learning model (“figurative_model_v1”) to the model repository 506 for storage. The augmented training dataset and test data (dataset1[XTrain,XTest]) may also be transmitted to the model repository 506. The figurative model producer 504 further transmits a request 530 to the sensitivity analyser 508 to perform sensitivity analysis on the two local machine learning models, as described above with respect to step 304.

Thus, the method shown in FIG. 3 provides a method for identifying input data features which lead to the local model (and hence the remote model) being biased.

The above methods have focused on particular input data features which are correlated with and thus introduce bias. However, bias can also be introduced by a training dataset that is imbalanced. Training a machine learning model with an imbalanced training dataset results in a model that has non-equal (skewed target variable distribution) numbers of samples for some of the classes, e.g., in a class predictor model. This is not important if the training dataset and test dataset are from the same label distribution. However, if the training and test datasets are from different distributions, the model may tend to be biased towards a class which had a greater number of samples in the training dataset.

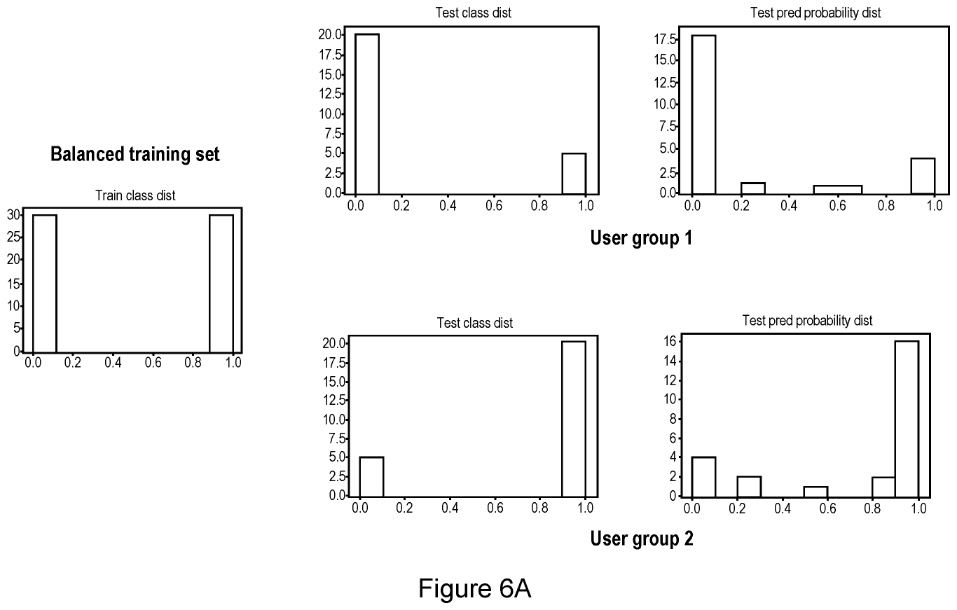

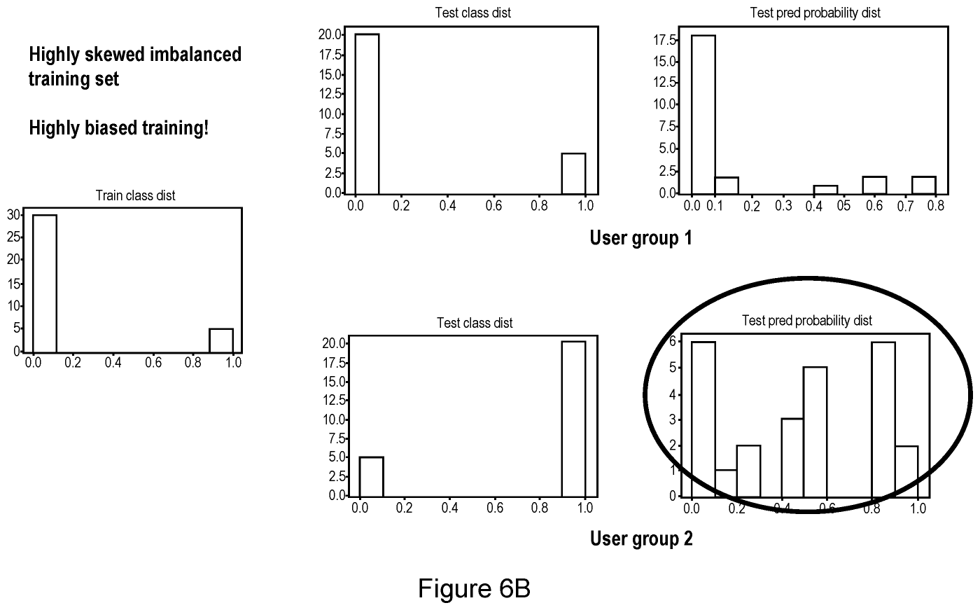

This problem can be seen in FIGS. 6A and 6B, with respect to a binary, potentially biasing parameter. In FIG. 6A, the machine learning model is trained using a training dataset that is balanced with respect to the biasing parameter: equal numbers of data samples in the training dataset are associated with the two possible values of the biasing parameter. In FIG. 6B, the machine learning model is trained using a training dataset that is imbalanced with respect to the biasing parameter: far more of the data samples in the training dataset are associated with the biasing parameter equal to ‘0’, than with the biasing parameter equal to ‘1’.

Each machine learning model is provided with two groups of test data in which the distributions with respect to the biasing parameter are different: user group 1, in which the majority of the input data is associated with the biasing parameter equal to ‘0’; and user group 2, in which the majority of the input data is associated with the biasing parameter equal to ‘1’.

It can be seen that the machine learning model in FIG. 6A, trained with the balanced training dataset, performs well with respect to both user groups. The prediction probability distribution closely approximates the distribution of both user groups. The machine learning model in FIG. 6B performs well for user group 1, as the distribution of user group 1 is similar to that of the training dataset. However, the machine learning model in FIG. 6B performs poorly for user group 2.

FIG. 7 is a flowchart of a method for mitigating the effect of bias according to further embodiments of the disclosure and particularly describes a method in which the training dataset is configured so as to reduce bias. The method may be performed by the model analyser 130 described above, and sets out an example of the processing which may take place in steps 204 and 206 described above with respect to FIG. 2. Thus, the method may proceed in the context of a local model that has been trained, e.g., using a training dataset obtained as set out in steps 200 and 202 described above, to approximate a remote machine learning model.

The purpose of the method shown in FIG. 7, as with the method shown in FIG. 3, is to identify whether the remote model is biased with respect to a biasing parameter. As noted above, a biasing parameter is a data parameter, which may be present in the input data features provided to the local model or not, against which the local model performs poorly (e.g., inaccurately). As with FIG. 3, the candidate biasing parameters may be selected from the plurality of data parameters which are available to the model analyser. That is, the model analyser may be aware of additional data parameters than those which form the input data samples in the training dataset. For example, where the model analyser is implemented within a consumer device, the model analyser will generally have access to numerous data parameters relating to the characteristics, function and performance of the consumer device, and not only those which are included within the input data samples sent to the remote model. Where the model analyser is implemented outside a consumer device, the model analyser may request additional information corresponding to the one or more candidate biasing parameters from the consumer devices.

In step 700, the model analyser inputs test dataset to the remote model or the local model and obtains output data from the remote model or the local model. The test dataset is provided from data having a plurality of data distributions with respect to a candidate biasing parameter. That is, the test dataset comprises at least first test dataset having a first distribution with respect to the candidate biasing parameter and second test dataset having a second, different distribution with respect to the candidate biasing parameter (and potentially additional data having further different distributions with respect to the candidate biasing parameter).

Table 1 shows example data, comprising three test datasets, each having different data distributions with respect to a binary candidate biasing parameter X_{bias}. Test dataset 1 is dominated by data samples in which the candidate biasing parameter is equal to 1; test dataset 2 is dominated by data samples in which the candidate biasing parameter is equal to 0; and test dataset 3 is balanced between data samples in which the candidate biasing parameter is equal to 0 and 1. In practice, the test sets may comprise many more data samples than those shown in Table 1.

TABLE 1

| | | |
|---|---|---|
| Test dataset 1 | Test dataset 2 | Test dataset 3 |

| X_{-f}_{_{—}}_{bias} | y | X_{-f}_{_{—}}_{bias} | Y | X_{-f}_{_{—}}_{bias} | Y |
|---|---|---|---|---|---|
| X1 | 1 | X11 | 1 | X21 | 1 |
| X2 | 1 | X12 | 1 | X22 | 1 |
| X3 | 0 | X13 | 1 | X23 | 1 |
| X4 | 0 | X14 | 1 | X24 | 1 |
| X5 | 0 | X15 | 1 | X25 | 1 |
| X6 | 0 | X16 | 1 | X26 | 0 |
| X7 | 0 | X17 | 1 | X27 | 0 |
| X8 | 0 | X18 | 1 | X28 | 0 |
| X9 | 0 | X19 | 0 | X29 | 0 |
| X10 | 0 | X20 | 0 | X30 | 0 |

In step 702, the performance of the model with respect to each test dataset is compared. If the model is not biased (where equal amount of examples are shown to the model during the training from both vendors), then similar accuracy should be achieved regardless of the data distribution of the biasing parameter. In the example of Table 1, similar accuracy should be achieved in test datasets 1, 2 and 3. In this case, the method may end at step 702.

However, if the performance of the model differs with respect to each test dataset, this is an indication that the model is biased with respect to the biasing parameter. For example, the model analyzer may determine that the model is biased if the performance of the model with respect to a first test dataset differs from the performance of the model with respect to a second test dataset by more than a threshold amount; or if the performance of the model with respect to a first test dataset differs from an average performance of the model with respect to other test datasets by more than a threshold amount.

Further, the relative performance of the model with respect to the different test datasets may be indicative of the distribution of the data in the training dataset. See FIG. 6B. The machine learning model trained on the imbalanced dataset performs well on test dataset which has a similar distribution to the imbalanced dataset. Thus, the test dataset which generates the highest accuracy may be indicative of the distribution in the training dataset with respect to the biasing parameter. In other words, the training dataset may have a similar data distribution with respect to the biasing parameter as the test dataset for which the highest accuracy was achieved.

If the model is found to be biased with respect to the biasing parameter, the method proceeds to step 704 in which the training dataset on which the local model is trained (see, e.g., steps 200 and 202 described above) is adapted so as to mitigate the bias identified in step 702.

The training dataset may be augmented with data samples taken from a particular biasing parameter value which is under-represented, such that the overall training dataset becomes balanced. Such data samples may be real, or synthesized based on the distribution of the existing data associated with the particular biasing parameter value.

In step 706, the local model is then over-trained or retrained using the balanced training dataset and a machine learning process (such as neural networks and XGBoost, which enable the local model to be fine-tuned, rather than retrained from the start).

The present disclosure thus provides methods for identifying whether a remote model is biased, and then mitigating that bias by identifying input data features that are associated with the bias and retraining a local model using data in which those input data features have been removed. The disclosure also provides apparatus and machine-readable mediums for performing the methods described above.

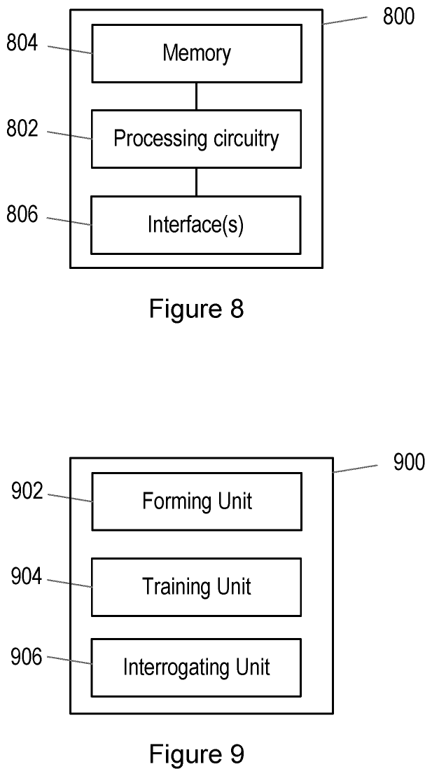

FIG. 8 is a schematic diagram of an apparatus 800 according to embodiments of the disclosure. The apparatus 800 may be, for example, the model analyser 130 described above with respect to FIG. 1. The apparatus 800 may be operable to carry out the methods described with reference to FIGS. 2, 3 and 7, and possibly any other processes or methods disclosed herein. It is also to be understood that the methods of FIGS. 2, 3 and 7 may not necessarily be carried out solely by the apparatus 800. At least some operations of the method can be performed by one or more other entities.

The apparatus 800 comprises processing circuitry 802 (such as one or more processors, digital signal processors, general purpose processing units, etc), a machine-readable medium 804 (e.g., memory such as read-only memory (ROM), random-access memory, cache memory, flash memory devices, optical storage devices, etc) and one or more interfaces 806.

In one embodiment, the machine-readable medium 804 stores instructions which, when executed by the processing circuitry 802, cause the apparatus 800 to: form a training dataset comprising input data samples provided to a remote machine learning model developed using a machine learning process, and corresponding output data samples obtained from the remote model; train a local machine learning model which approximates the remote machine learning model using a machine learning process and the training dataset; and interrogate the trained local machine learning model to determine whether the remote machine learning model is biased with respect to one or more biasing data parameters.

In other embodiments, the processing circuitry 802 may be configured to directly perform the method, or to cause the apparatus 800 to perform the method, without executing instructions stored in the non-transitory machine-readable medium 804, e.g., through suitably configured dedicated circuitry.

The one or more interfaces 806 may comprise hardware and/or software suitable for communicating with other nodes of the communication network using any suitable communication medium. For example, the interfaces 806 may comprise one or more wired interfaces, using optical or electrical transmission media. Such interfaces may therefore utilize optical or electrical transmitters and receivers, as well as the necessary software to encode and decode signals transmitted via the interface. In a further example, the interfaces 806 may comprise one or more wireless interfaces. Such interfaces may therefore utilize one or more antennas, baseband circuitry, etc. The components are illustrated coupled together in series; however, those skilled in the art will appreciate that the components may be coupled together in any suitable manner (e.g., via a system bus or suchlike).

In further embodiments of the disclosure, the apparatus 800 may comprise power circuitry (not illustrated). The power circuitry may comprise, or be coupled to, power management circuitry and is configured to supply the components of apparatus 800 with power for performing the functionality described herein. Power circuitry may receive power from a power source. The power source and/or power circuitry may be configured to provide power to the various components of apparatus 800 in a form suitable for the respective components (e.g., at a voltage and current level needed for each respective component). The power source may either be included in, or external to, the power circuitry and/or the apparatus 800. For example, the apparatus 800 may be connectable to an external power source (e.g., an electricity outlet) via an input circuitry or interface such as an electrical cable, whereby the external power source supplies power to the power circuitry. As a further example, the power source may comprise a source of power in the form of a battery or battery pack which is connected to, or integrated in, the power circuitry. The battery may provide backup power should the external power source fail. Other types of power sources, such as photovoltaic devices, may also be used.

FIG. 9 is a schematic diagram of an apparatus 900 for determining bias of machine learning models according to embodiments of the disclosure. The apparatus 900 may be, for example, the model analyser 130 described above with respect to FIG. 1. The apparatus 900 may be operable to carry out the methods described with reference to FIGS. 2, 3 and 7, and possibly any other processes or methods disclosed herein. It is also to be understood that the methods of FIGS. 2, 3 and 7 may not necessarily be carried out solely by the apparatus 900. At least some operations of the method can be performed by one or more other entities.

The apparatus 900 comprises a forming unit 902, which is configured to form a training dataset comprising input data samples provided to a remote machine learning model developed using a machine learning process, and corresponding output data samples obtained from the remote model. The apparatus 900 further comprises a training 904, which is configured to train a local machine learning model which approximates the remote machine learning model using a machine learning process and the training dataset. The base station 900 further comprises an interrogating unit 906 configured to interrogate the trained local machine learning model to determine whether the remote machine learning model is biased with respect to one or more biasing data parameters.

Thus, for example, the forming unit 902, training unit 904, and interrogating unit 906 may be configured to perform steps 200, 202 and 204 (described above in respect of FIG. 2) respectively.

The apparatus 900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause the forming unit 902, training unit 904, and interrogating unit 906, and any other suitable units of base station 900 to perform corresponding functions according one or more embodiments of the present disclosure.

The apparatus 900 may additionally comprise power-supply circuitry (not illustrated) configured to supply the apparatus 900 with power.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method for determining bias of machine learning models, comprising:
forming a training dataset comprising input data samples provided to a remote machine learning model developed using a machine learning process, and corresponding output data samples obtained from the remote machine learning model;
training a local machine learning model which approximates the remote machine learning model using a machine learning process and the training dataset; and
interrogating the trained local machine learning model to determine whether the remote machine learning model is biased with respect to one or more biasing data parameters.

2. The method according to claim 1, wherein interrogating the local machine learning model comprises:
augmenting the training dataset with the one or more biasing data parameters as input features, to create an augmented training dataset;
retraining the local machine learning model using the machine learning process and the augmented training dataset;
determining an importance of the one or more biasing data parameters to the retrained local machine learning model; and
based on the determined importance of the one or more biasing data parameters to the retrained local machine learning model, determining whether the remote machine learning model is biased with respect to the one or more biasing data parameters.

3. The method according to claim 2, wherein the importance of the one or more biasing parameters is quantified by respective Shapley values associated with the one or more biasing data parameters.

4. The method according to claim 2, wherein whether the remote machine learning model is biased with respect to the one or more biasing data parameters is further based on a comparison of an accuracy of the local machine learning model to an accuracy of the retrained local machine learning model.

5. The method according to claim 1, further comprising performing one or more actions to mitigate bias with respect to the one or more biasing parameters.

6. The method according to claim 5, wherein the one or more actions comprise augmenting the training dataset with the one or more biasing parameters as labels to create an alternative training dataset, and training a further machine learning model using a machine learning process and the alternative training dataset, the further machine learning model being trained to generate the one or more biasing parameters as labels based on the input data samples.

7. The method according to claim 6, further comprising determining an importance of input data features to the further machine learning model, based on the determined importance of the one or more input data features to the further machine learning model, removing one or more input data features from the training dataset to obtain an unbiased training dataset, and retraining the local machine learning model using the machine learning process and the unbiased training dataset.

8. The method according to claim 7, wherein the steps of training the further machine learning model, determining an importance of input data features to the further machine learning model, and removing one or more input data features from the training dataset are performed iteratively.

9. The method according to claim 7, wherein the step of removing one or more input data features from the training dataset comprises removing one or more input data features which contribute most to the further machine learning model

10. The method according to claim 9, wherein the step of removing one or more input data features from the training dataset comprises removing the one or more input data features associated with the largest Shapley values in the further machine learning model.

11. The method according to claim 7, further comprising storing an indication of the one or more input data features removed from the training dataset, to be used in debiasing other machine learning models.

12. The method according to claim 7, wherein retraining the local machine learning model using the machine learning process and the unbiased training dataset comprises inputting input data samples of the unbiased training dataset to the local machine learning model, inputting input data samples of the training dataset to the remote machine learning model, and adapting the local machine learning model so as to reduce or minimize a difference between outputs of the local machine learning model and the remote machine learning model

13. The method according to claim 1, wherein the method is performed by a network node in a communications network.

14. The method according to claim 13, wherein the input data samples and corresponding output data samples are received from one or more wireless devices coupled to the communications network.

15. The method according to claim 1, wherein one or more of the following applies: the remote machine learning model provides an output on the basis of which a radio access network operation is performed; the remote machine learning model provides an output on the basis of which an action is performed in a smart factory; the remote machine learning model provides an output on the basis of which an autonomous vehicle operation is performed; and the remote mode provides an output on the basis of which a medical procedure is performed.

16. An apparatus for determining bias of machine learning models, comprising processing circuitry and a machine-readable medium storing instructions which, when executed by the processing circuitry, cause the apparatus to:
form a training dataset comprising input data samples provided to a remote machine learning model developed using a machine learning process, and corresponding output data samples obtained from the remote machine learning model;
train a local machine learning model which approximates the remote machine learning model using a machine learning process and the training dataset; and
interrogate the trained local machine learning model to determine whether the remote machine learning model is biased with respect to one or more biasing data parameters.

17. The apparatus according to claim 16, wherein the apparatus is caused to interrogate the local machine learning model by:
augmenting the training dataset with the one or more biasing data parameters as input features, to create an augmented training dataset;
retraining the local machine learning model using the machine learning process and the augmented training dataset;
determining an importance of the one or more biasing data parameters to the retrained local machine learning model; and
based on the determined importance of the one or more biasing data parameters to the retrained local machine learning model, determining whether the remote machine learning model is biased with respect to the one or more biasing data parameters.

18.-21. (canceled)

22. The apparatus according to claim 21, wherein the one or more actions further comprise determining an importance of input data features to the further machine learning model, based on the importance of the one or more input data features to the further machine learning model, removing one or more input data features from the training dataset to obtain an unbiased training dataset, and retraining the local machine learning model using the machine learning process and the unbiased training dataset.

23. The apparatus according to claim 22, wherein the apparatus is caused to train the further machine learning model, determine an importance of input data features to the further machine learning model, and remove one or more input data features from the training dataset iteratively.

24.-27. (canceled)

28. The apparatus according to claim 16, wherein the apparatus is a network node in a communications network.

29.-21. (canceled)
